(19) United States
(12) Patent Application Publication
(10) Pub. No.: US 2008/0117622 A1
(43) Pub. Date: May 22, 2008

(54) Foldable lighting device for barbecue stove

(76) Inventor: Chun-Cheng Lin, Taichung County (TW)

Correspondence Address: BACON & THOMAS, PLLC, 625 SLATERS LANE, FOURTH FLOOR, ALEXANDRIA, VA, 22314, US

(21) Appl. No.: 11/600,094

(22) Filed: Nov. 16, 2006

(51) Int. Cl. F21V 33/00; A47J 37/07

(52) U.S. Cl. 362/92

(57) ABSTRACT

A lighting device for a barbecue stove includes a fixing seat mounted on a faceplate of the barbecue stove, a lamp body detachably mounted on the fixing seat, a lighting member mounted on a first end of the lamp body, a drive member mounted on a second end of the lamp body to drive the lamp body, and a magnetic member mounted on the drive member. Thus, the magnetic member of the lighting device is magnetically attached to a metallic surface located at any position of the barbecue stove so that the lighting device is arbitrarily attached to any position of the barbecue stove to provide a lighting effect.

### BACKGROUND OF THE INVENTION

1. Field of the Invention

The present invention relates to a lighting device, and more particularly to a foldable lighting device for a barbecue stove.

2. Description of the Related Art

A conventional barbecue stove comprises an upright support, a stove body mounted on a top of the support, a lid removably mounted on a top of the stove body, a control panel mounted on a front portion of the stove body, and a plurality of control knobs rotatably mounted on the control panel. However, the conventional barbecue stove is not provided with a lighting device to provide a lighting effect, so that the conventional barbecue stove is not available for use at a dark place.

### SUMMARY OF THE INVENTION

The present invention is to mitigate and/or obviate the disadvantage of the conventional barbecue stove.

The primary objective of the present invention is to provide a foldable lighting device for a barbecue stove.

Another objective of the present invention is to provide a lighting device, wherein the magnetic member of the lighting device is magnetically attached to a metallic surface located at any position of the barbecue stove so that the lighting device is arbitrarily attached to any position of the barbecue stove to provide a lighting effect, thereby enhancing the versatility of the lighting device.

A further objective of the present invention is to provide a lighting device, wherein the lighting member of the lighting device is pivotable relative to the lamp body to adjust an angle between the lighting member and the lamp body to facilitate a user operating the lighting device.

A further objective of the present invention is to provide a lighting device, wherein the lighting device is hidden in the faceplate when not in use, so that only the drive member of the lighting device is partially protruded outwardly from the faceplate, thereby saving the space of storage of the lighting device.

A further objective of the present invention is to provide a lighting device, wherein the drive member of the lighting device has an outlook corresponding to that of each of the control knobs to enhance the outer appearance of the lighting device.

In accordance with the present invention, there is provided a lighting device, comprising a fixing seat, a lamp body detachably mounted on the fixing seat, a lighting member mounted on a first end of the lamp body, a drive member mounted on a second end of the lamp body to drive the lamp body, and a magnetic member mounted on the drive member.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a barbecue stove in accordance with the preferred embodiment of the present invention;

FIG. 2 is a partially exploded perspective view of the barbecue stove as shown in FIG. 1;

FIG. 3 is a partially perspective view of the barbecue stove as shown in FIG. 1;

FIG. 4 is a partially plan cross-sectional view of the barbecue stove as shown in FIG. 3;

FIG. 5 is a schematic operational view of the barbecue stove as shown in FIG. 4;

FIG. 6 is a schematic operational view of the barbecue stove as shown in FIG. 1; and

FIG. 7 is a partially plan cross-sectional operational view of the barbecue stove as shown in FIG. 6.

### DETAILED DESCRIPTION OF THE INVENTION

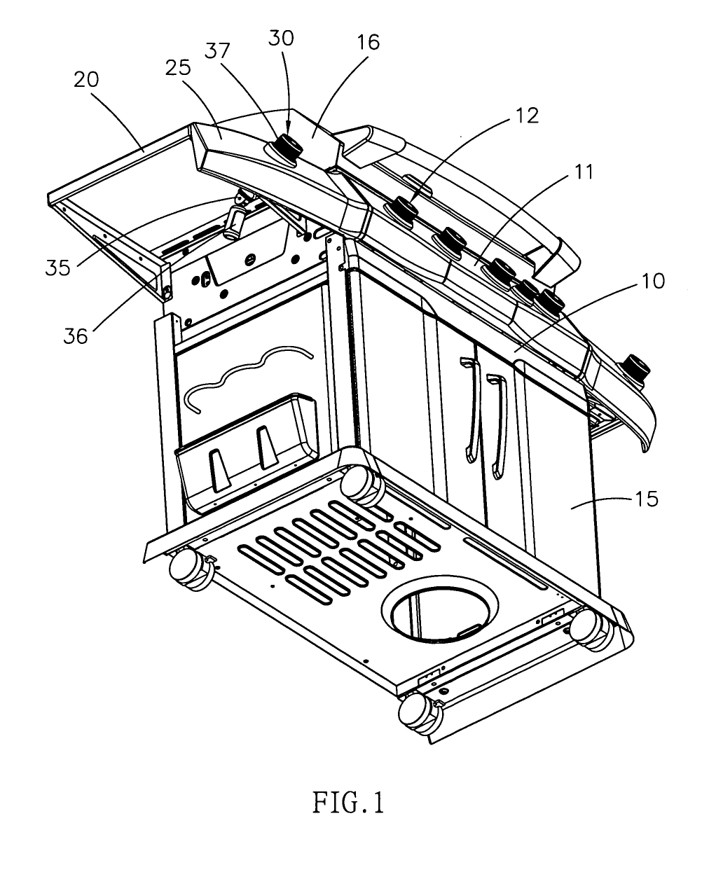

Referring to the drawings and initially to FIGS. 1-5, a barbecue stove in accordance with the preferred embodiment of the present invention comprises an upright support 15, a stove body 10 mounted on a top of the support 15, a lid 16 removably mounted on a top of the stove body 10, a control panel 11 mounted on a front portion of the stove body 10, a plurality of control knobs 12 rotatably mounted on the control panel 11, at least one side frame 20 mounted on a side of the stove body 10, a faceplate 25 mounted on a front portion of the side frame 20, and a lighting device 30 detachably mounted on the faceplate 25.

The lighting device 30 includes a fixing seat 31 mounted on the faceplate 25, a lamp body 35 detachably mounted on the fixing seat 31, a lighting member 36 mounted on a first end of the lamp body 35, a drive member 37 mounted on a second end of the lamp body 35 to drive the lamp body 35, and a magnetic member 39 mounted on the drive member 37.

The fixing seat 31 of the lighting device 30 has an annular shape and is locked onto the faceplate 25 of the barbecue stove. The fixing seat 31 of the lighting device 30 has an inner periphery formed with a locking plate 32. The locking plate 32 of the fixing seat 31 has an annular shape and has a side formed with a plurality of entrance slots 33 which are equally spaced from each other.

The lighting member 36 of the lighting device 30 is pivotally mounted on the lamp body 35 so that the lighting member 36 of the lighting device 30 is pivotable relative to the lamp body 35 to adjust an angle between the lighting member 36 and the lamp body 35. The lighting member 36 of the lighting device 30 contains a light emitting element (not shown) therein to emit light outwardly from the lighting member 36. The lighting member 36 of the lighting device 30 is fully hidden in the faceplate 25 as shown in FIG. 1.

The lamp body 35 of the lighting device 30 contains a chargeable battery (not shown) therein to supply an electric power to the lighting member 36. The lamp body 35 of the lighting device 30 is fully hidden in the faceplate 25 as shown in FIG. 1.

The drive member 37 of the lighting device 30 is secured to the second end of the lamp body 35 and is rotatably mounted on the fixing seat 31. The drive member 37 of the lighting device 30 has a periphery provided with a plurality of protruding locking blocks 38 each inserted into a respective entrance slot 33 of the locking plate 32 and each locked in the locking plate 32 of the fixing seat 31 by rotation of the drive member 37 relative to the fixing seat 31. The locking blocks 38 of the drive member 37 are equally spaced from each other. The drive member 37 of the lighting device 30 is partially protruded outwardly from the faceplate 25 as shown in FIG. 1. The drive member 37 of the lighting device 30 has an outlook corresponding to that of each of the control knobs 12 to enhance the outer appearance of the lighting device 30.

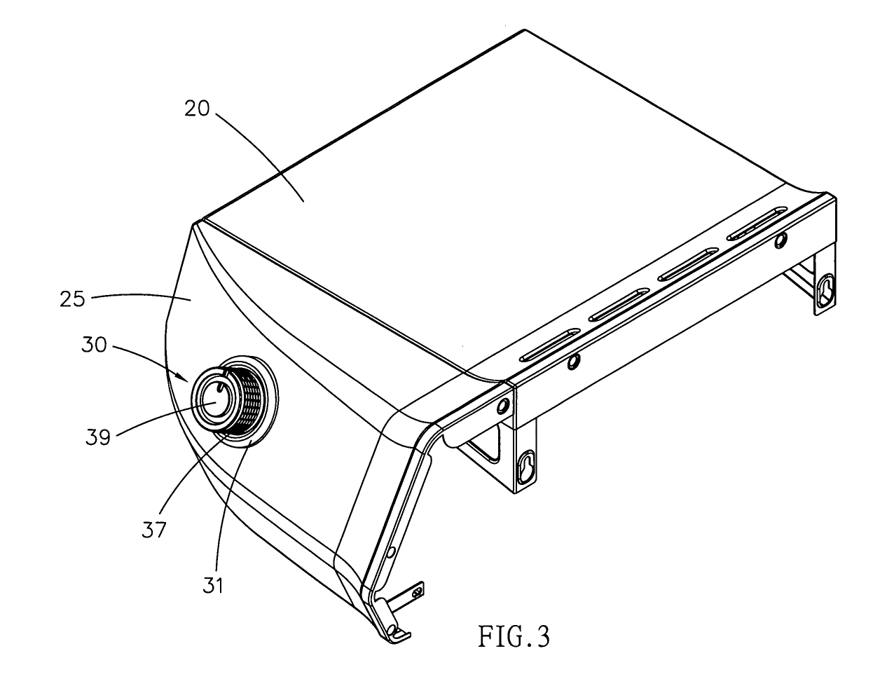

The magnetic member 39 of the lighting device 30 is mounted on an end face of the drive member 37 and is protruded outwardly from the faceplate 25 as shown in FIG. 3. The magnetic member 39 of the lighting device 30 is magnetically attached to a metallic surface 18 of the barbecue stove when the lamp body 35 is detached from the fixing seat 31.

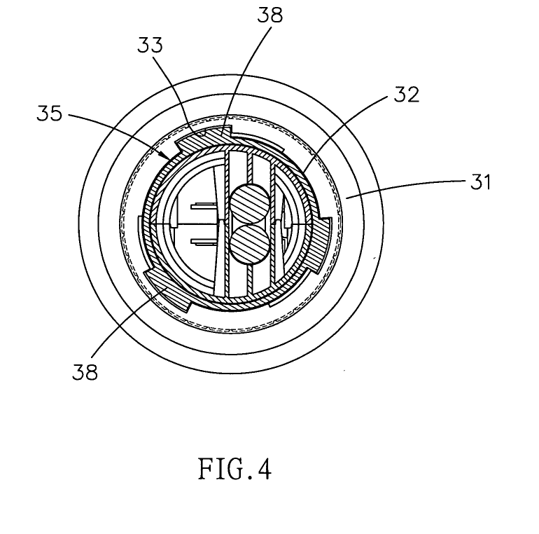

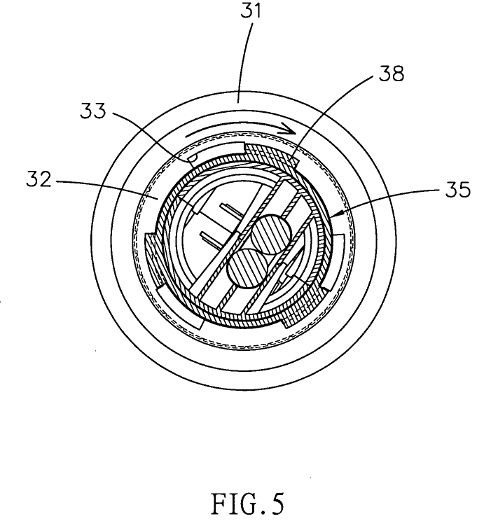

In assembly, each of the locking blocks 38 of the drive member 37 is inserted into the respective entrance slot 33 of the locking plate 32 as shown in FIG. 4. Then, the drive member 37 is rotated relative to the fixing seat 31 as shown in FIG. 5, so that each of the locking blocks 38 of the drive member 37 is introduced through the respective entrance slot 33 into the locking plate 32 and is limited by an inner face of the locking plate 32 to lock the drive member 37 onto the fixing seat 31 so as to attach the lighting device 30 to the faceplate 25 as shown in FIG. 3.

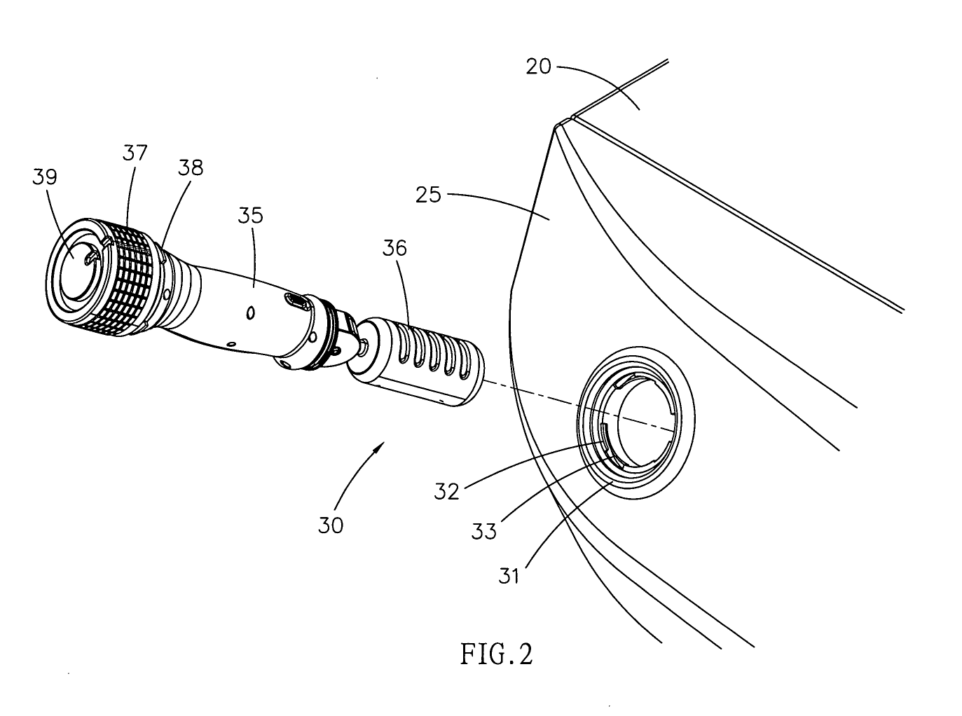

On the contrary, the drive member 37 is rotated relative to the fixing seat 31 in the reverse direction, so that each of the locking blocks 38 of the drive member 37 is detached from the inner face of the locking plate 32 and is aligned with the respective entrance slot 33 of the locking plate 32. Then, the drive member 37 is pulled outwardly relative to the fixing seat 31 to detach each of the locking blocks 38 of the drive member 37 from the respective entrance slot 33 of the locking plate 32 so as to release the lighting device 30 from the faceplate 25 as shown in FIG. 2.

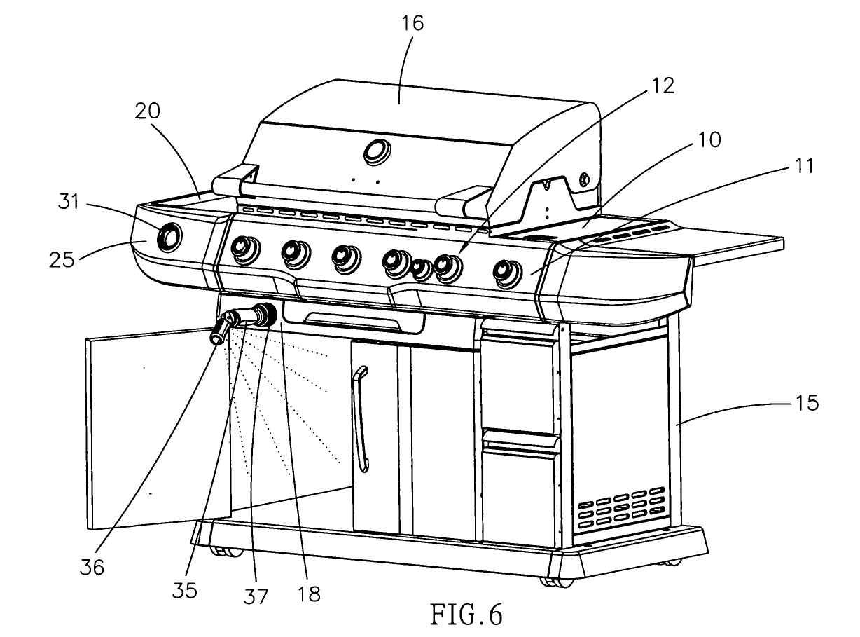

As shown in FIGS. 2 and 6, after the lighting device 30 is removed from the faceplate 25, the magnetic member 39 of the lighting device 30 is magnetically attached to a metallic surface 18 located at any position of the barbecue stove to attach the lighting device 30 to any position of the barbecue stove so as to provide a lighting effect.

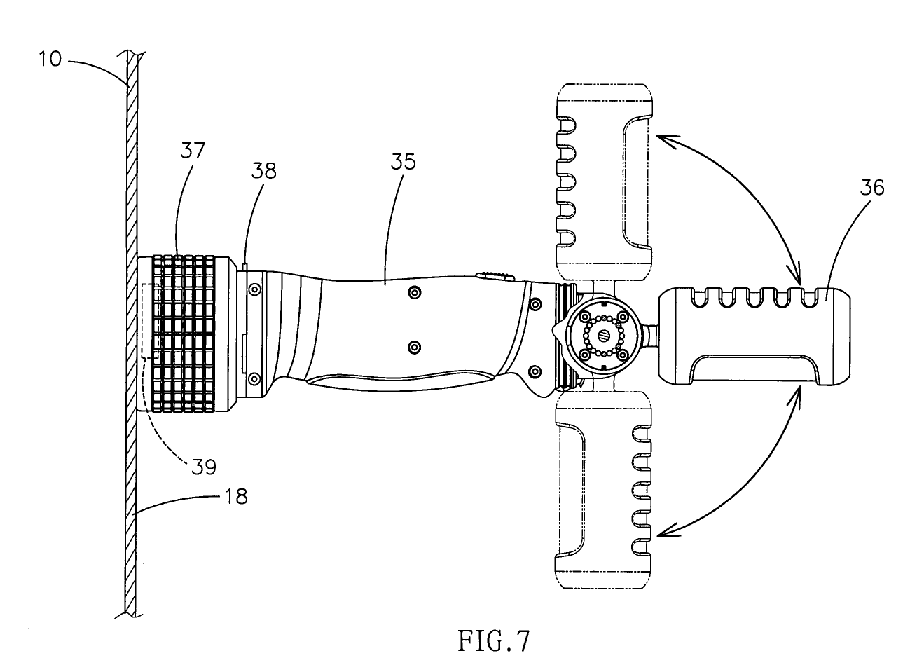

As shown in FIG. 7, the lighting member 36 of the lighting device 30 is pivotable relative to the lamp body 35 to adjust an angle between the lighting member 36 and the lamp body 35 to facilitate a user operating the lighting device 30.

Accordingly, the magnetic member 39 of the lighting device 30 is magnetically attached to a metallic surface 18 located at any position of the barbecue stove so that the lighting device 30 is arbitrarily attached to any position of the barbecue stove to provide a lighting effect, thereby enhancing the versatility of the lighting device 30. In addition, the lighting member 36 of the lighting device 30 is pivotable relative to the lamp body 35 to adjust an angle between the lighting member 36 and the lamp body 35 to facilitate a user operating the lighting device 30. Further, the lighting device 30 is hidden in the faceplate 25 when not in use, so that only the drive member 37 of the lighting device 30 is partially protruded outwardly from the faceplate 25, thereby saving the space of storage of the lighting device 30. Further, the drive member 37 of the lighting device 30 has an outlook corresponding to that of each of the control knobs 12 to enhance the outer appearance of the lighting device 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A lighting device, comprising:
a fixing seat;
a lamp body detachably mounted on the fixing seat;
a lighting member mounted on a first end of the lamp body;
a drive member mounted on a second end of the lamp body to drive the lamp body;
a magnetic member mounted on the drive member.

2. The lighting device in accordance with claim 1, wherein the fixing seat has an inner periphery formed with a locking plate, the locking plate of the fixing seat has a side formed with a plurality of entrance slots, and the drive member has a periphery provided with a plurality of protruding locking blocks each inserted into a respective entrance slot of the locking plate and each locked in the locking plate of the fixing seat by rotation of the drive member relative to the fixing seat.

3. The lighting device in accordance with claim 2, wherein the locking plate of the fixing seat has an annular shape.

4. The lighting device in accordance with claim 2, wherein the entrance slots of the locking plate are equally spaced from each other.

5. The lighting device in accordance with claim 2, wherein the locking blocks of the drive member are equally spaced from each other.

6. The lighting device in accordance with claim 1, wherein the fixing seat has an annular shape.

7. The lighting device in accordance with claim 1, wherein the lighting member is pivotally mounted on the lamp body so that the lighting member is pivotable relative to the lamp body to adjust an angle between the lighting member and the lamp body.

8. The lighting device in accordance with claim 1, wherein the drive member is secured to the second end of the lamp body.

9. The lighting device in accordance with claim 1, wherein the drive member is rotatably mounted on the fixing seat.

10. The lighting device in accordance with claim 1, wherein the magnetic member is mounted on an end face of the drive member.

11. The lighting device in accordance with claim 1, wherein the fixing seat is mounted on a faceplate of a barbecue stove.

12. The lighting device in accordance with claim 11, wherein the fixing seat is locked onto the faceplate of the barbecue stove.

13. The lighting device in accordance with claim 11, wherein the lighting member is fully hidden in the faceplate of the barbecue stove.

14. The lighting device in accordance with claim 11, wherein the lamp body is fully hidden in the faceplate of the barbecue stove.

15. The lighting device in accordance with claim 11, wherein the drive member of the lighting device is partially protruded outwardly from the faceplate of the barbecue stove.

16. The lighting device in accordance with claim 11, wherein the magnetic member is protruded outwardly from the faceplate of the barbecue stove.

17. The lighting device in accordance with claim 11, wherein the magnetic member is magnetically attached to a metallic surface of the barbecue stove when the lamp body is detached from the fixing seat.

18. The lighting device in accordance with claim 11, wherein the drive member has an outlook corresponding to that of a control knob of the barbecue stove.

19. The lighting device in accordance with claim 17, wherein the metallic surface is located at any position of the barbecue stove.

20. The lighting device in accordance with claim 2, wherein the drive member is rotatable relative to the fixing seat, so that each of the locking blocks of the drive member is introduced through the respective entrance slot into the locking plate and is limited by an inner face of the locking plate to lock the drive member onto the fixing seat.
